(19) United States
(12) Patent Application Publication
(10) Pub. No.: US 2017/0234755 A1
(43) Pub. Date: Aug. 17, 2017

(54) Variability Compensation For Paired Shafts and Sensors

(71) Applicant: Ford Global Technologies, LLC, Dearborn, MI (US)

(72) Inventors: Gregory Michael Pietron, Canton, MI (US); Yuji Fujii, Ann Arbor, MI (US); John Edward Brevick, Livonia, MI (US); Jeffrey Martin Hinkle, South Lyon, MI (US); Michael John Leads, Farmington Hills, MI (US)

(21) Appl. No.: 15/045,405

(22) Filed: Feb. 17, 2016

(51) Int. Cl. G01L 25/00; G01L 3/10

(52) U.S. Cl. CPC G01L 25/003; G01L 3/101; F16H 61/0204

(57) ABSTRACT

A transmission utilizes an output torque sensor that relies upon magnetization of a section of the output shaft. The sensor produces an electrical current that varies as the torque transmitted by the shaft varies. However, the relationship between output torque and electrical current is impacted by part-to-part variability of the shaft and of the sensor. Conventional methods of compensating for this variability are hampered because the sensors and shafts are not paired until they are assembled into the transmission. A portable test may be used to characterize each shaft and each sensor. This characterization data includes average zero torque current and variability of zero torque current with respect to shaft position. A mapping is selected based on the shaft characterization and the sensor characterization and programmed into the controller.

### TECHNICAL FIELD

This disclosure relates to the field of vehicle controls. More particularly, the disclosure pertains to a method of calibrating a torque sensor.

### BACKGROUND

Many vehicles are used over a wide range of vehicle speeds, including both forward and reverse movement. Some types of engines, however, are capable of operating efficiently only within a narrow range of speeds. Consequently, transmissions capable of efficiently transmitting power at a variety of speed ratios are frequently employed. Transmission speed ratio is the ratio of input shaft speed to output shaft speed. When the vehicle is at low speed, the transmission is usually operated at a high speed ratio such that it multiplies the engine torque for improved acceleration. At high vehicle speed, operating the transmission at a low speed ratio permits an engine speed associated with quiet, fuel efficient cruising.

A common type of automatic transmission includes a gearbox capable of alternately establishing a fixed number of power flow paths, each associated with a fixed speed ratio. The gearbox includes a number of shift elements such as clutches and brakes. A particular power flow path is established by engaging a particular subset of the shift elements. To shift from one power flow path to another power flow path with a different speed ratio, one or more shift elements must be released while one or more other shift elements must be engaged. Some shift elements may be passive devices such as one way clutches, while other shift elements engage or disengage in response to commands from a controller. For example, in many automatic transmissions, the shift devices are hydraulically controlled friction clutches or brakes. The controller regulates the torque capacity of the shift element by regulating an electrical current to a solenoid, which adjusts a force on a valve which, in turn, adjusts a pressure in a hydraulic circuit.

Most transmissions are equipped with a launch device. When the vehicle is stationary or moving very slowly, the gearbox input speed is less than the minimum operating speed of the engine. A launch device transmits torque from the engine to the gearbox input while permitting the engine to rotate at an acceptable speed. A common launch device is a torque converter which includes an impeller driven by the engine and a turbine driving the gearbox input. Torque is transferred from the impeller to the turbine hydro-dynamically. Many torque converters also include a hydraulically controlled lock-up clutch that couples the impeller to the turbine, bypassing the hydro-dynamic power transfer path to improve efficiency at higher vehicle speeds. Other transmissions use an actively controlled launch clutch as a launch device.

A modern automatic transmission is controlled by a microprocessor which adjusts the torque capacity of each shift element, including any lock-up clutch, at regular intervals. At each interval, the controller gathers information indicating the driver's intent, such as the positions of the shifter (PRNDL), the accelerator pedal, and the brake pedal. The controller also gathers information about the current operating state of the vehicle, engine, and transmission, such as the speed of various elements and the torque transmitted by various elements. Using this information, the controller determines whether to maintain the currently established power flow path or to shift to a different power flow path. If the controller decides to shift to a different power flow path, the controller then adjusts the torque capacities of the off-going shift elements and the on-coming shift elements in a coordinated manner in order to make the transition as smoothly as possible.

The capability to shift smoothly depends on the ability to accurately determine operating state of the vehicle from sensor inputs. Various noise factors complicate this by influencing the relationship between the sensed quantity and the sensor output. These noise factors include environmental conditions such as temperature, component wear over time, and part-to-part variability in the manufacturing process. Methods which measure and compensate for these noise factors improve the ability to accurately determine operating state and therefore improve the ability to control the transmission.

### SUMMARY OF THE DISCLOSURE

A method of manufacturing transmission includes fabricating a plurality of shafts and sensors, testing each of the shafts and sensors, assembling the transmissions, and entering compensation data into controllers based on the test results. Each shaft has a magnetized section adapted for use with a magneto-elastic torque sensor. Each production shaft is tested with a master torque sensor, which may be either a pre-selected torque sensor with known sensitivity or may be an alternative magnetic flux sensing instrument. Similarly, each production sensor is tested with a master shaft, which may be either a pre-selected shaft with known magnetic signature or may be an alternative device that emits a known magnetic signature. The testing may produce characterizing data such as average zero torque electrical output and a metric of electrical output variability with respect to rotational position. The characterizing data may be utilized to identify a range for each shaft and a range for each sensor which are then used to select the compensation data to be entered into each controller.

### BRIEF DESCRIPTION OF THE DRAWINGS

FIG. 1 is a schematic representation of a vehicle powertrain.

FIG. 2 is a schematic cross section of a transmission output shaft with an output torque sensor.

FIG. 3 is a flow chart for a first method of adjusting data in a controller to account for part-to-part variability of the shaft and the sensor unit.

FIG. 4 is a schematic cross section of a portable tester suitable for performing some of the test steps in the method of FIG. 3.

FIG. 5 is a flow chart for a second method of adjusting data in a controller to account for part-to-part variability of the shaft and the sensor unit.

FIG. 6 is a flow chart for a third method of adjusting data in a controller to account for part-to-part variability of the shaft and the sensor unit.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

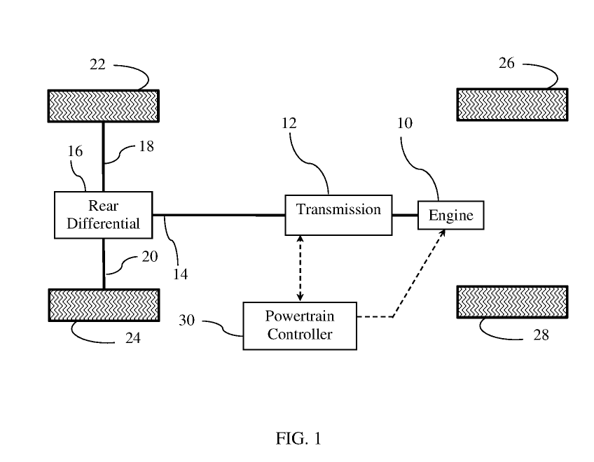

FIG. 1 schematically illustrates a powertrain of a rear wheel drive vehicle. Mechanical connections are illustrated with solid lines while dotted lines represent signals that convey information. Power to propel the vehicle is generated by internal combustion engine 10. This power is conditioned to satisfy vehicle needs by transmission 12 and delivered to rear driveshaft 14. In particular, when the vehicle is at low speed, transmission 12 reduces the speed and multiplies the torque relative to the power provided by the engine. When the vehicle is at high speed, transmission 12 causes driveshaft 14 to rotate faster than the engine crankshaft. Rear differential 16 divides the power from driveshaft 14 between left and right rear axles 18 and 20 which drive left and right rear wheels 22 and 24 respectively. Differential 16 permits the two axles to rotate at slightly different speeds relative to one another when the vehicle turns a corner. Differential 16 also multiplies the driveshaft torque by a fixed ratio called the final drive ratio and changes the axis of rotation by 90 degrees. Left and right front wheels, 26 and 28 respectively, are not powered. In a front wheel drive vehicle, the engine and transmission are typically oriented parallel to the front axle and the differential is typically integrated with the transmission in an assembly called a transaxle.

Transmission 12 establishes various power flow paths having different speed ratios by selectively engaging and disengaging a number of shift elements. Controller 30 adjusts the torque capacity of on-coming and off-going friction clutches during shift events. For some types of transmissions, such as dual clutch transmissions, controller 30 also continuously adjusts the torque capacity of one of more clutches to launch the vehicle from a stationary position. Controller 30 may utilize signals from transmission 12, such as input and output speed and torque sensors. Controller 30 may also send control signals to engine 10 to adjust the torque output of the engine.

One known type of torque sensor is based on materials that have magnetic properties which change in response to shear strain. When a shaft transmits torque, the surface of the shaft deflects in shear. For a given shaft geometry, the surface shear strain is proportional to the torque transmitted by the shaft. A magneto-elastic torque sensor produces an electrical signal that varies in response to the change in the magnetic field. A controller can estimate the transmitted torque by processing the electrical signal. Such a torque sensor is described in U.S. Pat. No. 6,698,299.

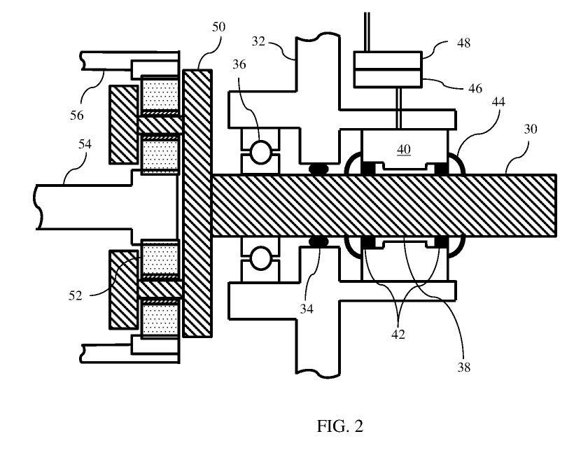

FIG. 2 illustrates one way of installing an output shaft torque sensor in a rear wheel drive transmission. Transmission output shaft 30 protrudes from the rear portion of transmission housing 32. A seal 34 may preclude contaminants from getting inside the housing. The transmission output shaft may be supported with respect to the housing by ball bearings 36 which locate the shaft both axially and radially. A section of the output shaft surface 38 behind the transmission case is treated to produce a magnetic field that fluctuates with fluctuations in the output shaft torque. A sensor 40 is mounted to the housing 32 in close proximity to the treated section of the output shaft. The clearance between the sensor and the shaft surface is closely controlled using bearings 42. Seals 44 prevent contamination from entering the gap between the sensor and the shaft surface. A wiring harness attached to sensor 40 includes a plug 46 that connects with plug 48 of the transmission wiring harness. The output shaft may be fixed to a planetary carrier 50. Carrier 50 supports a number of planet gears 52 that mesh with a sun gear formed into shaft 54 and with a ring gear fixed to shell 56.

Several factors, in addition to shaft torque, influence the electrical signal generated by the sensor 40. These other factors are collectively known as noise factors. Accurately determining shaft torque requires measures to minimize and/or compensate for these factors. The noise factors include temperature and part-to-part variability of the shaft and the sensor components. One way to compensate for temperature is to test the sensor and shaft at a variety of known shaft torques and known temperatures to produce a map indicating shaft torque as a function of voltage and temperature. Using this map, the controller measures the voltage and temperature and looks up a corresponding torque value, interpolating as necessary.

Ideally, the testing that generates the map would be performed with the actual sensor and shaft used in the transmission. In that way, the map would also compensate for part-to-part variability of the shaft and sensor manufacturing processes. In practice, this may be impractical. The shafts and sensors may be manufactured by different suppliers and not paired to one another until the transmission is assembled. Once the transmission is assembled, it may be impractical to run the testing on every transmission at the necessary variety of known temperatures and known shaft torques.

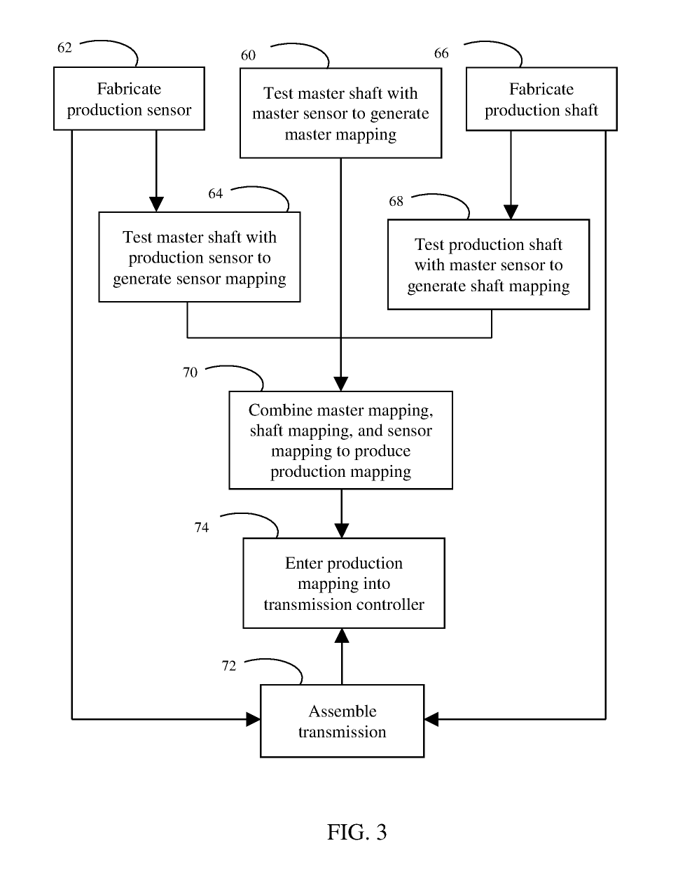

FIG. 3 illustrates a method of compensating for sensor and shaft part-to-part variability. At 60, an assembly including a representative shaft called a master shaft and representative sensor called a master sensor is tested. A master shaft may be an actual sensor shaft which is pre-selected for a known magnetic signature as a reference. Alternatively, it may be a device that emits a known magnetic signature whose magnitude and circumferential pattern may differ from those of an actual sensor shaft, but serve as a standardized reference. A master sensor may be an actual sensor unit with a known sensitivity to magnetic flux magnitude and patterns. Alternatively, it may be a magnetic flux sensing instrumentation with sufficient sensitivity to magnitude and spatial profiles to classify the magnetized shafts. This testing may be done at a full range of controlled temperatures and controlled shaft torques. The testing may be done by the transmission manufacturer, the shaft manufacturer, the sensor manufacturer, or a designated testing laboratory. This testing produces a master mapping. After the testing, the master shaft is provided to the sensor manufacturer and the master sensor is provided to the shaft manufacturer.

At 62, the sensor manufacturer fabricates a production sensor. At 64, the sensor manufacturer assembles the production sensor to the master shaft and runs tests. Since this testing is performed on every sensor, cost may dictate a less comprehensive set of controlled temperatures and controlled torques than the testing used to produce the master mapping. The result of this testing is a sensor mapping. Differences between the sensor mapping and the master mapping are attributable to part-to-part variability of the sensor manufacturing process. Similarly, at 66 and 68, a production shaft is fabricated and tested with the master sensor to produce a shaft mapping. When the production sensor and shaft are shipped to the transmission manufacturer, the sensor and shaft mapping are also transmitted to the transmission manufacturer. Alternatively, data that characterizes the difference between the sensor or shaft mapping and the master mapping may be transmitted. In a mass production environment, the shafts and sensors are marked or otherwise individually identified so that each unit is associated with a particular corresponding mapping.

Once a particular shaft and sensor are paired by the transmission manufacturer, the transmission manufacturer combines the master mapping, the shaft mapping, and the sensor mapping at 70 to produce a production mapping. One way to accomplish this is to compute differences between the master mapping and the sensor and shaft mappings respectively and add these differences to the master mapping. After the transmission is assembled at 72, the production mapping is entered into the transmission controller at 74. This production mapping at least partially compensates for the part-to-part variability of the sensor and the shaft. If there is interaction between the sensor variability and shaft variability, the production mapping does not capture that interaction. Also, if the sensor and shaft mappings are produced at the component manufacturing facility, the production mapping does not compensate for any changes that may occur while the components are in transit.

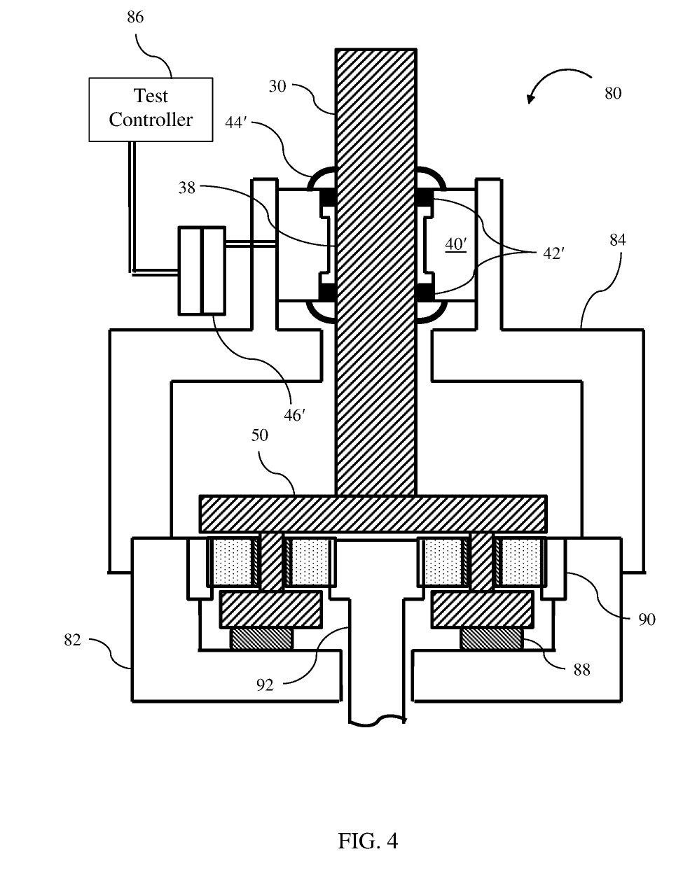

The process may be modified to compensate for changes in shaft magnetization that occur in transit by doing the shaft mapping at the assembly facility using a portable tester like the tester illustrated in FIG. 4. Tester 80 includes a pedestal 82, sensor housing 84, and a test controller 86. The shaft 30 is placed into the pedestal 82 such that the carrier rest on thrust bearings 88. A ring gear 90 may be fixed to the pedestal. A shaft 92 with a sun gear may extend into the pedestal from below. The output shaft is positioned radially such that the planet gears mesh with the sun gear and the ring gear. Sensor housing 84 includes the master sensor 40′, bearings 42′, and seals 44′. The sensor housing 84 slides over the production shaft 30. Sensor housing rests on pedestal 82 to locate the master sensor axial with respect to the magnetized region 38. The wiring harness of the master sensor is plugged into a wiring harness of the test controller. A very similar portable tester may be used to perform sensor testing on production sensors using a master shaft.

While no torque is applied to the shaft, the shaft may be rotated by rotating shaft 92. Test controller 86 measures and records the electric current at a number of different shaft rotational positions. If the maximum and/or minimum current are outside of a specification, the shaft may be discarded or returned for rework. This data may be processed to generate scalar values characterizing the average zero torque electrical output and the variability of zero torque electrical output as a function of rotational position. This testing may be repeated with a known torque applied to the exposed end of the shaft to characterize the rate of change of voltage with respect to torque. The tester may also include a temperature sensor to record the temperature at which the test results are taken. The test results may be shifted to compensate for temperature differences using temperature sensitivity data derived from the master mapping.

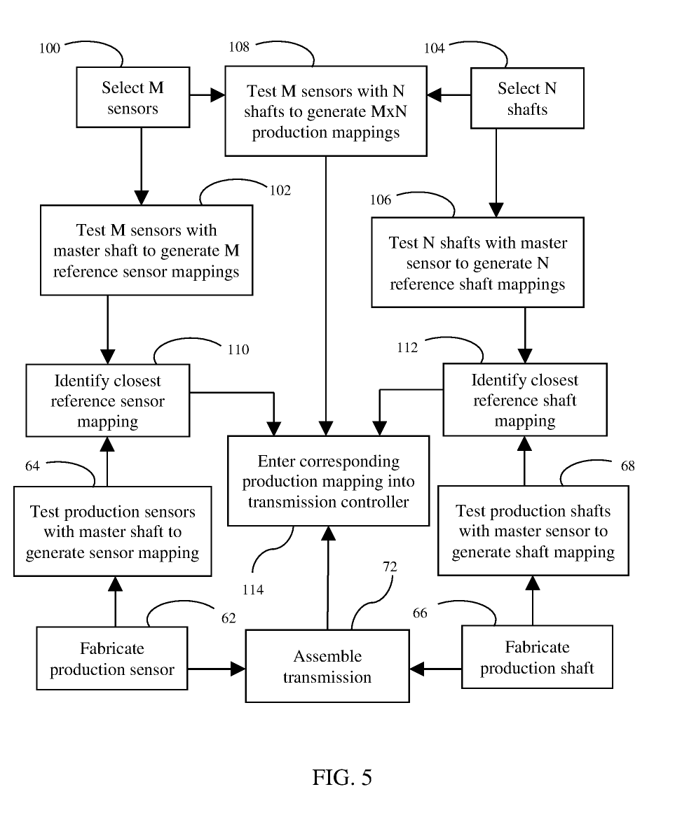

FIG. 5 illustrates an alternate method which compensates for interactions between shaft variability and sensor variability. At 100, M sensors are selected which represent the anticipated spectrum of sensor variability. Each of the M sensors is tested with a master shaft at 102 to create a set of M reference sensor mappings. A master shaft may be an actual sensor shaft with a known magnetic signature as a reference. Alternatively, it may be a device that emits a known magnetic signature whose magnitude and circumferential pattern may differ from those of an actual sensor shaft, but serve as a reference. The sensor testing may be simplified for producing a reduced sensor map to characterize sensor behaviors only under selected conditions that are sufficient for the purpose of sensor classification.

Similarly, at 104 and 106, N shafts representing the anticipated spectrum of shaft variability are tested with a master sensor to generate a set of N reference shaft mappings. A master sensor may be an actual sensor unit which is pre-selected for a known sensitivity to magnetic flux magnitude and spatial profiles. Alternatively, it may be a magnetic flux sensing instrumentation with adequate sensitivity to magnitude and spatial profiles to classify the magnetized shafts. The shaft testing may be simplified for a reduced shaft map to characterize magnetic behaviors only under selected conditions that are sufficient for the purpose of shaft classification. At 108, each selected sensor is tested with each selected shaft to generate M×N production mappings. As in FIG. 3, each production sensor is tested with the master shaft at 64 and each production shaft is tested with the master sensor at 68. Both shaft and sensor testing may be simplified to characterize magnetic behaviors only under selected conditions for the purpose of shaft and sensor classification, corresponding to the tests at 102 and 106. At 110, the sensor mapping is compared to the M reference sensor mappings to determine which of the M sensors most closely resembles the production sensor. For example, each reference sensor may be associated with a range of average electrical outputs at zero torque and a range of electrical output variability metrics. Similarly, at 112, the shaft mapping is compared to the N reference shaft mappings to determine which of the N shafts most closely resembles the production shaft. Like the reference sensors, each reference shaft may be associated with a range of average electrical outputs at zero torque and a range of electrical output variability metrics.

Then, at 114, the production mapping corresponding to the closest matches is entered into the controller. The testing performed at 108 to create the production mappings may be much more thorough than the testing performed at steps 102, 106, 110, and 112. To further increase the accuracy, the mapping entered into the controller may be modified based on the difference between the sensor mapping and the reference sensor mapping and/or the difference between the shaft mapping and the reference shaft mapping.

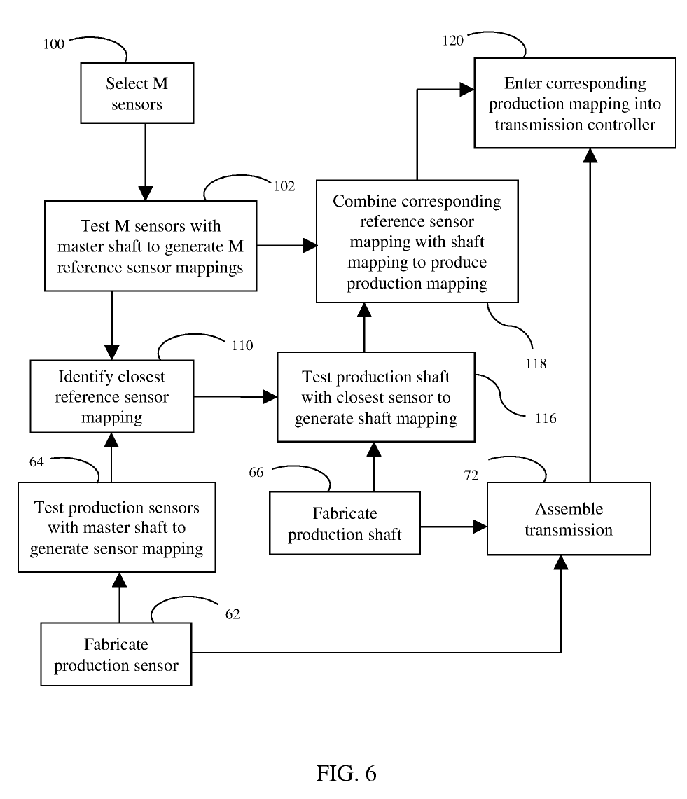

FIG. 6 describes a hybrid method. As in the method of FIG. 5, a representative set of sensors are selected at 100 and tested with the master shaft at 102. Unlike the method of FIG. 5, the testing performed at 102 should fully map the behavior over the entire range of torques and temperatures. The selected M sensors are then assembled into M portable testers. Each production sensor is tested at 64 and the closest reference sensor is selected at 110. After a production sensor and a production shaft are paired for use together in a transmission, the shaft is tested at 116 using the portable tester having the closest reference sensor. At 118, the reference sensor mapping corresponding to the closest sensor is modified based on the shaft mapping produced at 116 to produce a production mapping. For example, the reference sensor mapping may be shifted to have the average zero torque voltage as measured at 116. To further increase the accuracy, the mapping may also be modified based on the difference between the sensor mapping produced at 64 and the reference sensor mapping. Finally, at 120, the corresponding production mapping is entered into the controller.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A method of manufacturing transmissions comprising:
fabricating a plurality of shafts each having a magnetized section adapted for use with magneto-elastic torque sensors;
testing each of the plurality of shafts using a single master torque sensor and recording shaft characteristics for each of the plurality of shafts;
fabricating a plurality of magneto-elastic torque sensors;
testing each of the plurality of sensors using a single master shaft and recording sensor characterizing data for each of the plurality of sensors;
assembling a plurality of transmissions, each having one shaft of the plurality of shafts, one sensor of the plurality of sensors, and a controller; and
entering compensation data into each of the controllers based on the corresponding shaft characterizing data and sensor characterizing data.

2. The method of claim 1 wherein the single master torque sensor is a pre-selected torque sensor with a known sensitivity to magnetic flux magnitude and spatial profile.

3. The method of claim 1 wherein the single master torque sensor is magnetic flux sensing instrumentation.

4. The method of claim 1 wherein the single master shaft is a pre-selected shaft with a known magnetic signature.

5. The method of claim 1 wherein the single master shaft is a device configured to emit a known magnetic signature.

6. The method of claim 1 wherein the shaft characterizing data includes an average zero torque electrical output.

7. The method of claim 1 wherein the shaft characterizing data includes a metric of electrical output variability with respect to rotational position.

8. The method of claim 1 wherein the sensor characterizing data includes an average zero torque electrical output.

9. The method of claim 1 wherein the sensor characterizing data includes a metric of electrical output variability with respect to rotational position.

10. The method of claim 1 wherein entering the compensation data into each of the controllers comprises:
generating a plurality of production mappings associated with various ranges of shaft characteristics and sensor characteristics;
identifying in which range of shaft characteristics each shaft belongs;
identifying in which range of sensor characteristics each sensor belongs; and
entering the corresponding production mapping into each controller.

11. A method of manufacturing a transmission comprising:
assembling a shaft and a sensor into a transmission, the shaft associated with a shaft testing record reflecting test results for the shaft with a master torque sensor, the sensor associated with a sensor testing record reflecting test results for the sensor with a master shaft; and
entering compensation data into a transmission controller based on the shaft testing record and the sensor testing records.

12. The method of claim 11 further comprising:
inserting the shaft into a tester in which the master sensor is installed;
rotating the shaft with respect to the sensor;
measuring electrical output at various rotational positions; and
recording an average electrical output and a measure of electrical output variability with respect to rotational position into the shaft testing record.

13. The method of claim 11 further comprising:
inserting the sensor into a tester in which the master shaft is installed;
rotating the shaft with respect to the sensor;
measuring electrical output at various rotational positions; and
recording an average electrical output and a measure of electrical output variability with respect to rotational position into the sensor testing record.

14. The method of claim 11 wherein entering the compensation data into the controller comprises:
identifying a sensor range based on the sensor testing record;
identifying a shaft range based on the shaft testing record; and
entering a production mapping corresponding to the sensor range and shaft range into the controller.

15. A method of manufacturing transmissions comprising:
assembling a plurality of transmissions, each having a shaft, a sensor, and a controller, each shaft associated with a shaft testing record reflecting test results for the shaft with a master torque sensor, each sensor associated with a sensor testing record reflecting test results for the sensor with a master shaft; and
programming each controller with compensation data based on corresponding shaft and sensor testing records.

16. The method of claim 15 further comprising:
inserting each shaft into a tester in which the master sensor is installed;
for each shaft, measuring electrical output at various shaft rotational positions; and
for each shaft, computing an average electrical output and a measure of electrical output variability with respect to shaft rotational position.

17. The method of claim 15 further comprising:
inserting each sensor into a tester in which the master shaft is installed;
for each sensor, measuring electrical output at various shaft rotational positions; and
for each sensor, computing an average electrical output and a measure of electrical output variability with respect to shaft rotational position.

18. The method of claim 15 wherein programming the controllers with compensation data comprises:
identifying sensor ranges based on each sensor testing record;
identifying shaft ranges based on each shaft testing record; and
entering a production mappings corresponding to the corresponding sensor range and shaft range into each controller.
